(19) United States
(12) Patent Application Publication
(10) Pub. No.: US 2011/0096010 A1
(43) Pub. Date: Apr. 28, 2011

(54) TOUCH PANEL, ELECTRONIC DEVICE WITH TOUCH PANEL, AND TOUCH-PANEL-OPERATION SENSING METHOD

(76) Inventor: Kaneo TODOROKI, Kanagawa (JP)

(21) Appl. No.: 12/907,462

(22) Filed: Oct. 19, 2010

(30) Foreign Application Priority Data
Oct. 26, 2009 (JP) P2009-245589

(51) Int. Cl. G06F 3/041

(52) U.S. Cl. 345/173

(57) ABSTRACT

A touch panel includes an image creating part that creates a display image including operation buttons, a display part on which the display image is displayed, a touch sensor part in which logical switches are arranged, a storage unit in which to store information about relationships between the operation buttons and the logical switches, an operation detecting part that detects a touch on a displayed operation button, and an updating part that updates the information about the relationships between the touched operation buttons and the logical switches.

### BACKGROUND OF THE INVENTION

1. Field of the Invention

The present invention relates to a touch panel mountable to various types of electronic devices, an electronic device with the touch panel, and a touch-panel-operation sensing method used to sense operations performed on the touch panel.

2. Description of the Related Art

Mobile devices having a so-called touch panel have come into widespread use in recent years as mobile devices having a display panel. Various operations on a mobile device of this type are performed by touch operations, each of which is accomplished when a finger of the user or any operation device touches a panel surface.

There are various principles to detect the fact that the touch panel is touched by a finger or the like. Basically, a display area in which to sense a touch is divided horizontally and vertically at fixed intervals, and whether a touch is sensed is determined in each divided area. Touch-sensing switches are provided in each area in which to sense a touch. The touch-sensing switch is not limited to a physical switch or a switching element. A virtual switch calculated from an operation of a result sensed by a sensor may be used depending on the sensing principle. In an embodiment of the present invention, a switch of this type that senses a touch in a divided area on a touch panel is referred to as a logical switch. On the surface of the touch panel, logical switches of the type are disposed vertically and horizontally at fixed intervals, in a matrix.

An example of a touch panel in which touch position information is added to determine a touch position is described in Japanese Unexamined Patent Application Publication No. 2007-133610.

### SUMMARY OF THE INVENTION

A touch panel displays operation buttons thereon and determines that a displayed operation button has been operated when the touch panel detects the fact that a logical switch in a place where the operation button is displayed has been touched. It is important that there is a match between the place where the operation button is displayed and the position where the logical switch is arranged.

However, a surface of a display panel on which images are actually displayed is often positioned inside the display panel with a protective glass plate intervening between a surface of the display panel on which logical switch operations are detected and the surface on which images are displayed. When the user views the display panel in a direction orthogonal to the surface on which images are displayed, the place of an operation button displayed on the display panel completely matches the position of the corresponding logical switch. When, however, the user views the display panel at an angle, the position of the logical switch slightly differs from the place of the displayed operation button.

Accordingly, even if the user intends to touch an operation button, in practice, a logical switch may detect that the user touches a position deviating from the actual operation button. This may lower the operability of the touch panel depending on the direction in which the user views the touch panel. In particular, if relatively many operation buttons of a keyboard or the like are displayed on the display panel at small intervals, although the user intends to touch an operation button corresponding to a character, a press of another button adjacent to the touched button is often sensed.

Besides the problem with the direction of view, users often touch a position deviating from the center of a displayed operation button due to, for example, their operation habits. If, for example, a user tends to touch positions lower than the centers of displayed operation buttons, lower positions of the operation buttons are touched at all times and the touch to the position of an operation button may not be detected as intended by the user, depending on the degree of the deviation of the touched position from the intended position.

It is desirable to suitably detect operations on a touch panel regardless of differences in situations where individual users perform the operations.

According to an embodiment of the present invention, there is provided a touch panel that has an image creating part configured to create a display image including operation buttons and a display part on which the image created by the image creating part is displayed. When a display surface of the display part is touched, the touch is sensed by a plurality of logical switches arranged in a matrix in a sensing range. Information about relationships between the operation buttons displayed on the display part and the plurality of logical switches is stored in a storage unit. The information stored in the storage unit is used, and touch-sensing information about each of logical switches at positions corresponding to an operation button displayed on the display unit is added, the logical switches being part of the plurality of logical switches, and a touch on positions of the displayed operation button is detected in accordance with an added value. The information about relationships between the operation button and the logical switches corresponding to the operation button is updated in accordance with the touch-sensing information about each of the logical switches when the touch on the operation button was detected.

Accordingly, when a place where an operation button is displayed on the touch panel is touched by, for example, a user's finger, the touch is sensed by its corresponding logical switches. The pressed operation button can be determined in accordance with the stored information about the relationships between the logical switches and operation buttons and the added value of logical switches that sensed the pressing. When the operation button is determined to have been pressed, the information about the relationships between the operation buttons and the plurality of logical switches is updated in accordance with the distribution state of the logical switches that sensed the touch, so that an actual touch panel operation can be easily sensed.

According to the embodiment of the present invention, information about the relationship between operation buttons on a touch panel and a plurality of logical switches is updated in accordance with an actual operation situation. Therefore, even if a user tends to touch a place deviated in the same direction each time when pressing an operation button on the touch panel, the touch can be sensed correctly. Accordingly, even if a user has a specific habit when touching the display panel, the user's touch can be suitably sensed.

### BRIEF DESCRIPTION OF THE DRAWINGS

FIG. 1 is a block diagram showing an example of the entire structure of a device according to an embodiment of the present invention.

FIG. 2 illustrates an example of a device structure according to the embodiment.

FIG. 3 is a cross sectional view illustrating the main parts of the device in FIG. 2.

FIG. 4 illustrates an example of an arrangement of logical switches in the device in FIG. 2.

FIG. 5A illustrates an example of displayed operation buttons according to the embodiment, and FIG. 5B illustrates logical switches assigned in correspondence to the arrangement of the operation buttons.

FIG. 6A illustrates another example of displayed operation buttons according to the embodiment, and FIG. 6B illustrates logical switches assigned in correspondence to the arrangement of the operation buttons.

FIG. 7A illustrates another example of displayed operation buttons according to the embodiment, and FIG. 7B illustrates logical switches assigned in correspondence to the arrangement of the operation buttons.

FIG. 8 is a flowchart illustrating an example of a process carried out when a touch panel according to an embodiment of the present invention is operated.

FIGS. 9A to 9C illustrate an example of a process to update weighting values according to an embodiment of the present invention.

FIG. 10 is a flowchart illustrating the weighting value update process according to the embodiment.

FIGS. 11A and 11B illustrate an example in a case in which virtual buttons overlap in the weighting value update process in a variation of the embodiment.

FIG. 12 illustrates an example of a process to determine weighting values accumulated over a plurality of periods in the variation of the embodiment.

FIGS. 13A and 13B illustrate a relationship between virtual buttons and logical switches in the variation of the embodiment.

FIGS. 14A and 14B illustrate an example in which the place of a virtual button in FIGS. 13A and 13B is changed.

### DESCRIPTION OF THE PREFERRED EMBODIMENTS

An embodiment and variation of the present invention will be described in the following order:

### 1. Embodiment

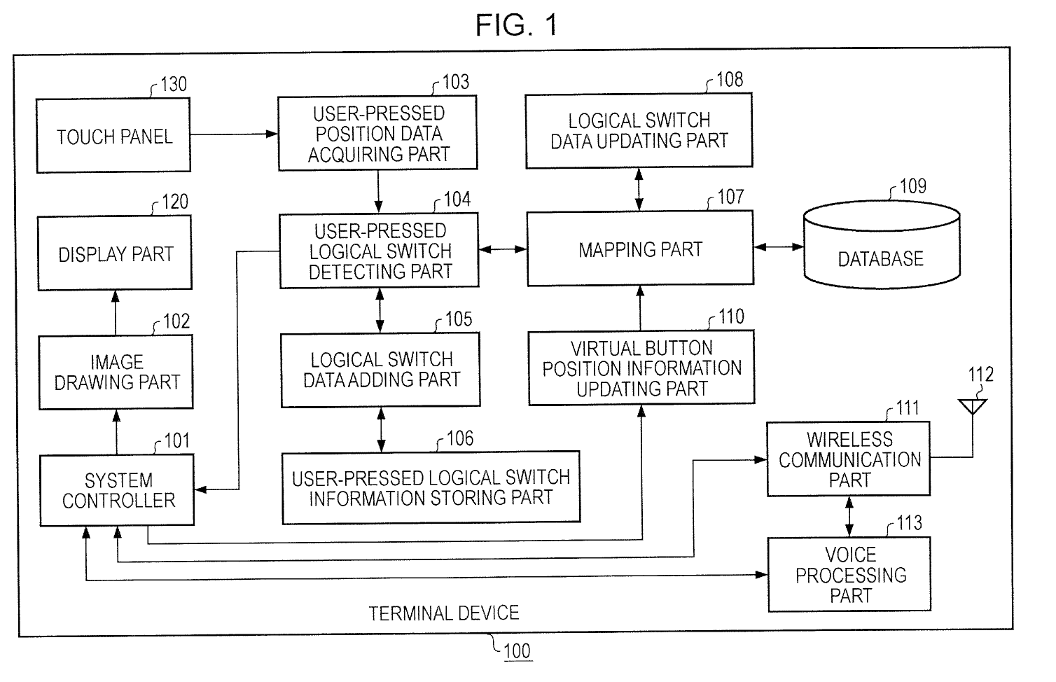

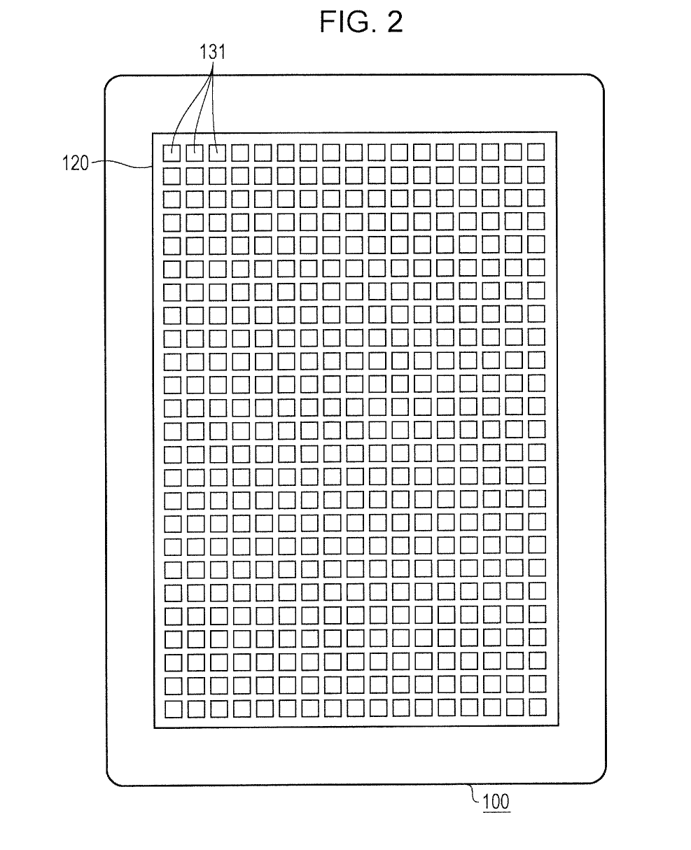

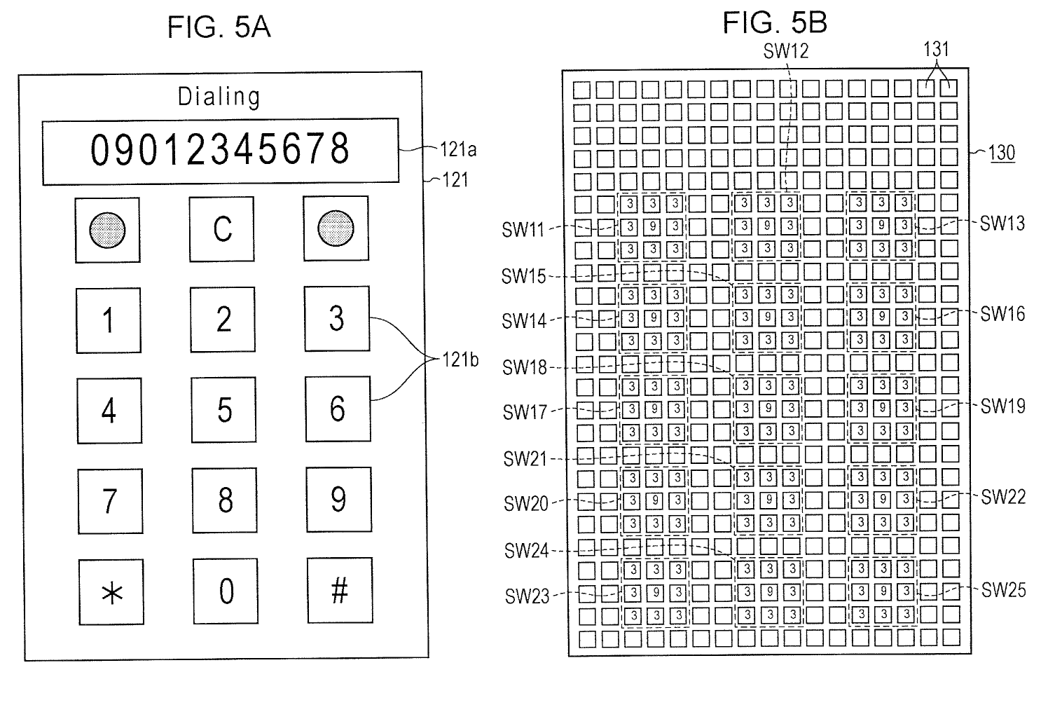

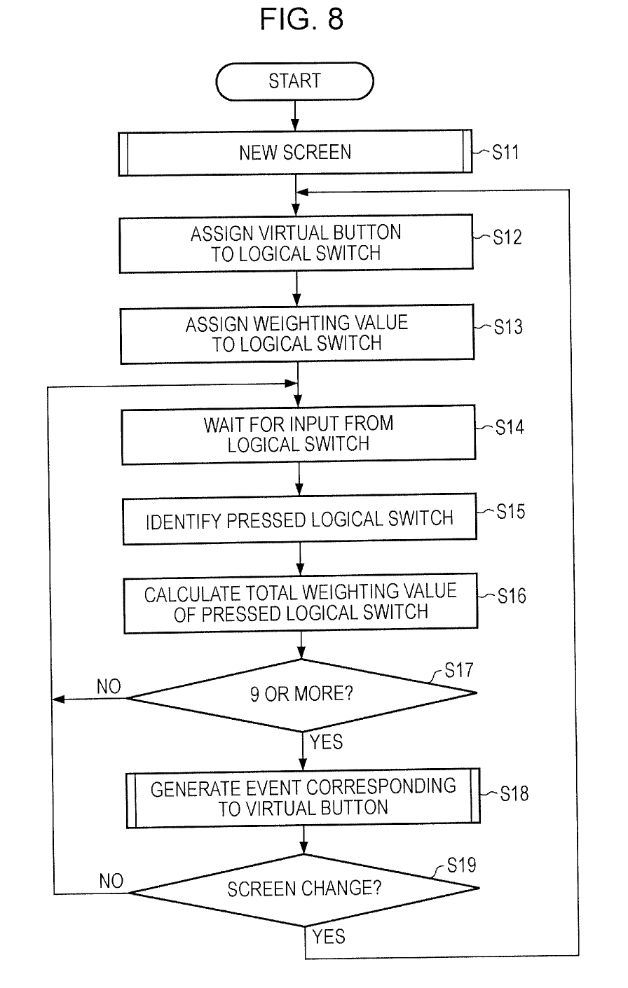

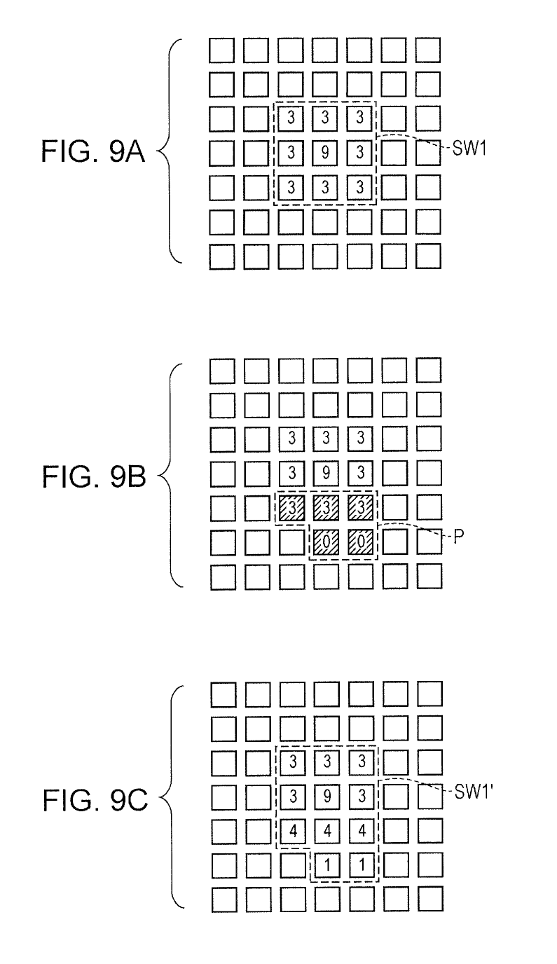

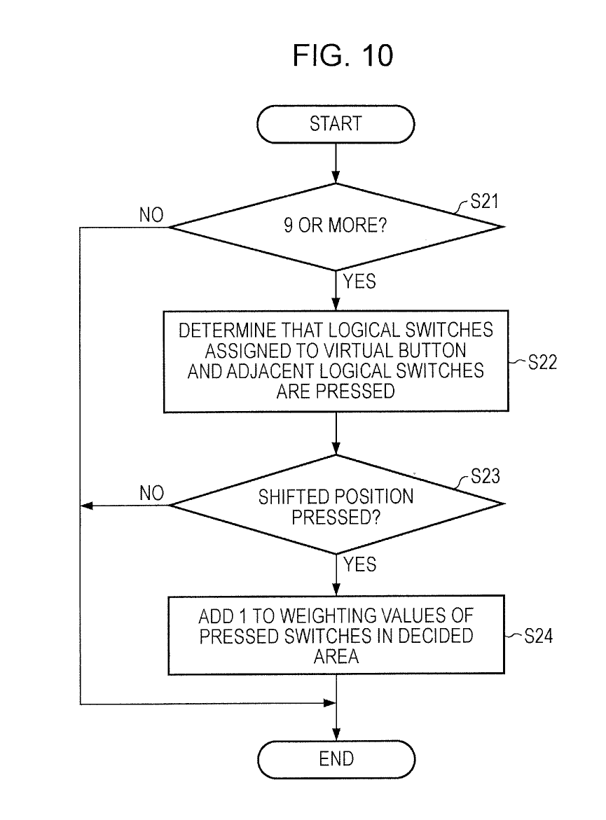

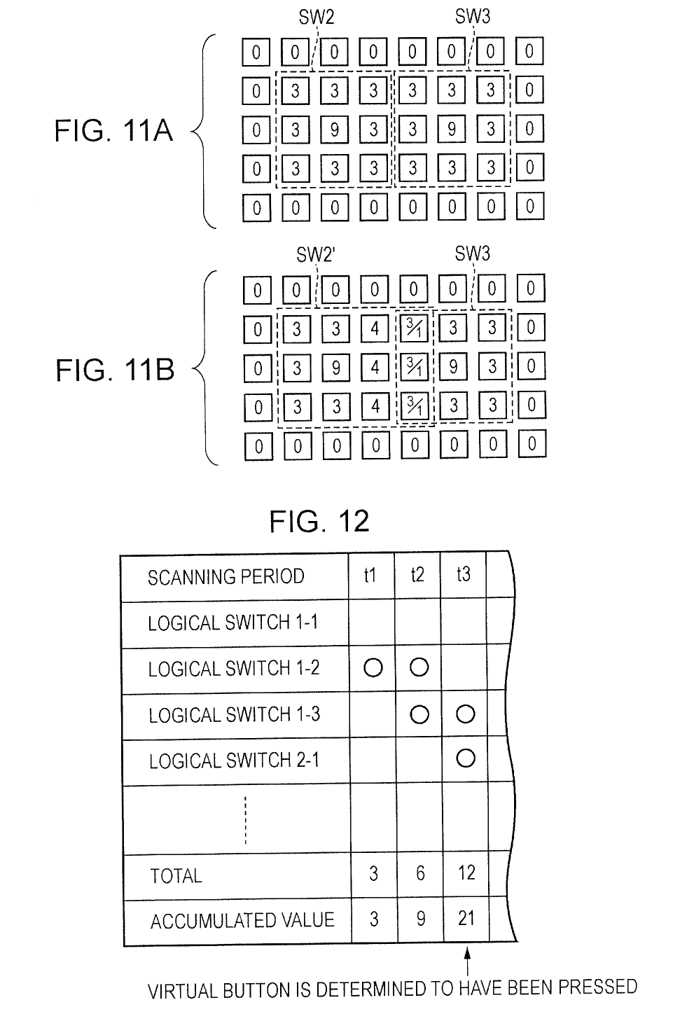

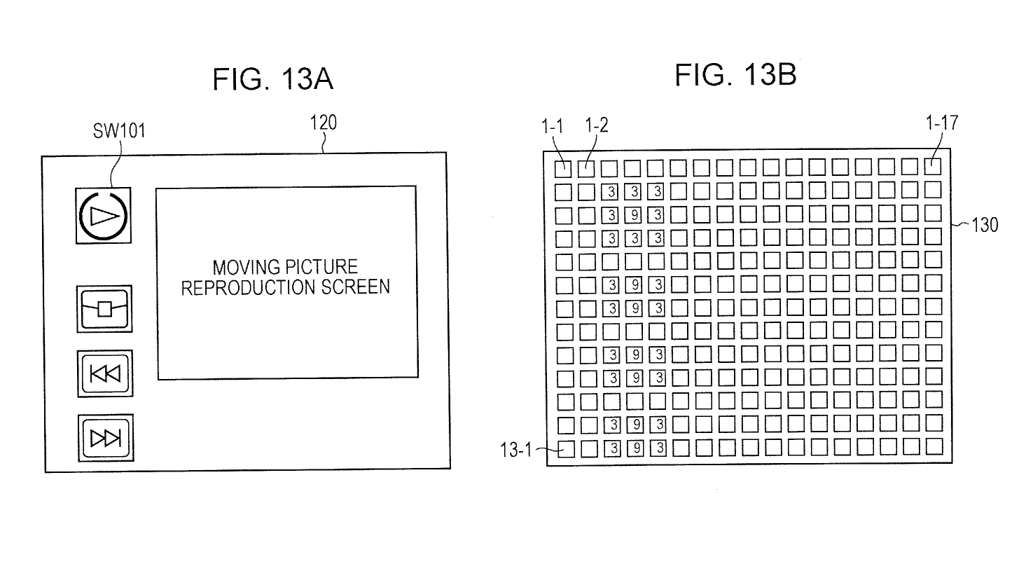

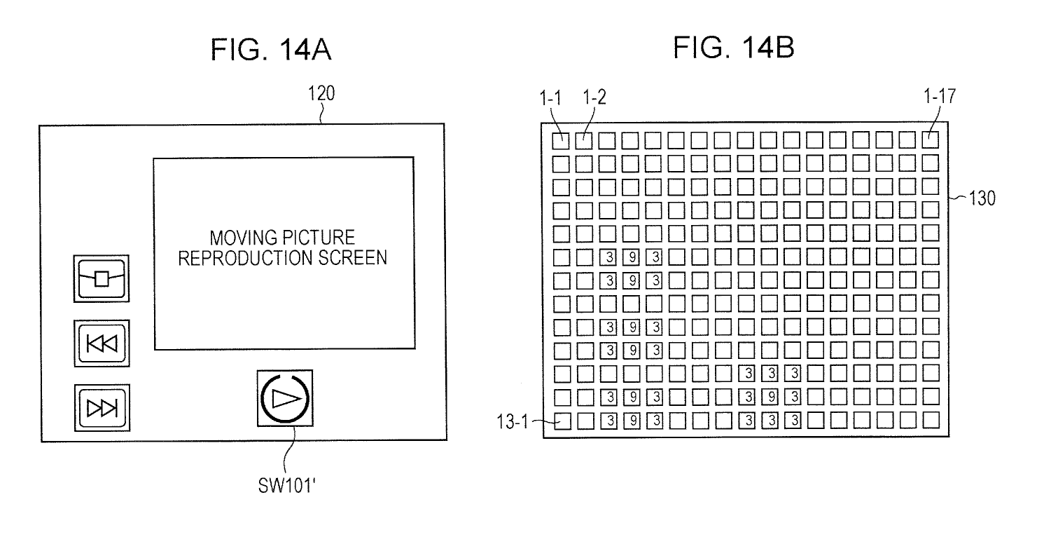

1.1 Exemplary device structure (FIG. 1)
1.2 Exemplary touch panel (FIGS. 2 to 4)
1.3 Exemplary virtual button arrangement (FIGS. 5A and 5B to FIGS. 7A and 7B)
1.4 Process to determine whether a virtual button has been operated (FIG. 8)
1.5 Exemplary weighting value update process (FIGS. 9A to 9C and FIG. 10)
2. Variation of the embodiment
2.1 Exemplary process when a plurality of buttons overlap (FIGS. 11a and 11b)
2.2 Exemplary process when values accumulated in a plurality of periods are used to make a decision (FIG. 12)
2.3 Example in which the place of a virtual button is changed (FIGS. 13A, 13B, 14A, and 14B)

### 1. Embodiment

An example in an embodiment of the present invention will be described with reference to FIGS. 1 to 10.

### 1.1 Exemplary Device Structure

First, the structure of a device in the example in this embodiment will be described with reference to FIG. 1. In the embodiment, a touch panel is attached to a terminal device 100 structured as a mobile telephone terminal.

The structure represented by the block diagram in FIG. 1 is shown mainly for an operation sensing function of the touch panel, which will be described in this embodiment.

As shown in FIG. 1, the terminal device 100 has a system controller 101, under control of which processing is executed in individual parts in the terminal device 100. For example, the system controller 101 controls voice input and output in a voice processing part 113 and wireless communication executed as a function of a mobile telephone terminal in a wireless communication part 111 to which an antenna 112 is connected.

The terminal device 100 also has a display part 120 on which images, characters, numerals, etc. are displayed. The display is controlled by the system controller 101. Specifically, an image drawing part 102, which is an image creating part, generates image signals during drawing, and these image signals are sent to and displayed on the display part 120 under control of the system controller 101. The display part 120 is formed by, for example, a liquid crystal image display panel or organic electro-luminescence (EL) image display panel.

The display part 120 includes a touch panel 130, which is a touch sensor part. When the display screen surface of the display part 120 is touched, the touch is sensed by a processing part connected to the touch panel 130. In the touch panel 130, logical switches are arranged vertically and horizontally in a matrix, as described below. A user-pressed position data acquiring part 103 acquires position data that indicates a position touched (pressed) on the panel. The position data acquired by the user-pressed position data acquiring part 103 is sent to a user-pressed logical switch detecting part 104, the position data being used as data that indicates logical switches touched on the touch panel 130. The data about the pressed logical switches is stored in a user-pressed logical switch information storing part 106 and is added in a logical switch data adding part 105. In this addition, an added value for each virtual button is obtained from virtual button information mapped in a mapping part 107, in accordance with correspondence between virtual buttons and logical switches stored in a database 109. In the database 109, which is a storage unit, information about the logical switches is prestored in correspondence to display places where operation buttons (virtual buttons) are displayed on the display part 120 of the terminal device 100. A displayed operation button, which senses a press on the touch panel 130, is a button virtually formed by being displayed, which will be referred to below as a virtual button.

In calculation of added values in the logical switch data adding part 105, the weighting value of each logical switch is added, as described later in detail. The obtained added value is sent from the user-pressed logical switch detecting part 104 to the system controller 101, where the pressed virtual button is determined.

Information about virtual buttons currently displayed on the display part 120 is sent to a virtual button position information updating part 110, and is used for mapping between the virtual buttons and logical switches in the mapping part 107. A logical switch data updating part 108 is connected to the mapping part 107 to update correspondence between the virtual buttons and logical switches stored in the database 109, as described later in detail.

Each part shown in FIG. 1 includes not only a part configured by a physical circuit and storage element but also a part formed by control operation processing by software.

### 1.2 Exemplary Touch Panel

Next, examples of the structures of the display part 120 and touch panel 130 will be described with reference to FIGS. 2 to 4.

As shown in FIG. 2, the terminal device 100 in this embodiment is structured so that a display panel 121, which is part of the display part 120, is arranged on the surface of a case configuring the main body of the terminal device and a plurality of logical switches 131 is consecutively arranged vertically and horizontally at fixed intervals on the surface of the display panel 121.

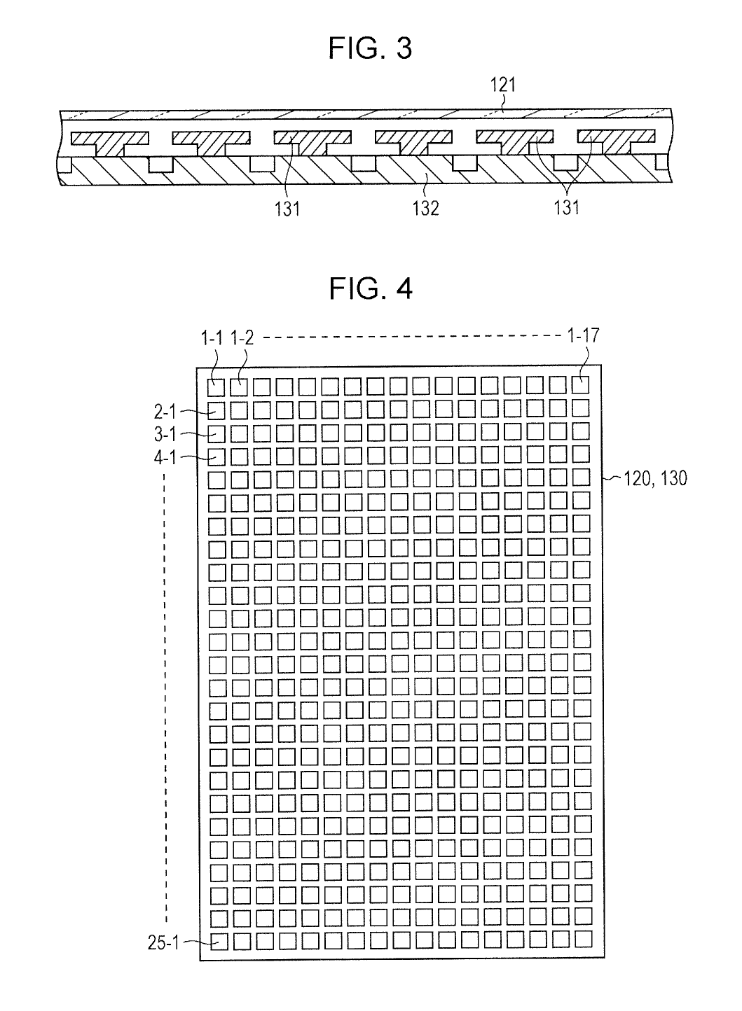

FIG. 3 is a cross sectional view of the display panel 121 and logical switches 131, indicating their relationship.

As shown in FIG. 3, the logical switches 131 are supported by support members 132 and arranged at fixed intervals at positions at which to place the logical switches on the display panel 121. When the user presses a place on the front surface of the display panel 121, logical switches 131 corresponding to the pressed place sense the press.

FIG. 3 illustrates one principle of the touch panel, so elements that sense presses may be disposed on the front surface of the display panel, for example. The logical switches 131 are disposed as shown in the drawing to sense a press as a result, so sensing elements, each of which is part of one logical switch 131, may not in one-to-one correspondence with the logical switches 131.

The logical switches 131, disposed vertically and horizontally at fixed intervals as shown in FIG. 2, are sequentially assigned different logical switch IDs as shown in FIG. 4. In the example in FIG. 4, logical switches are arranged in a matrix of 25 rows and 17 columns. On the top row, 1-1, 1-2, 1-3, . . . , 1-17 are sequentially assigned as IDs from the leftmost end; on the second row, 2-1, 2-2, 2-3, . . . , 2-17 are sequentially assigned similarly as IDs from the leftmost end; on the bottom row, 25-1, 25-2, 25-3, . . . , 25-17 are sequentially assigned similarly as IDs from the leftmost end.

### 1.3 Exemplary Virtual Button Arrangement

Examples of correspondence between the virtual buttons displayed on the display panel 121 and the matrix of the logical switches 131 disposed in the touch panel 130 are shown in FIGS. 5A and 5B to FIGS. 7A and 7B, different virtual buttons being shown in different drawings. The display panel 121 and the logical switch matrix are shown side by side in FIGS. 5A to 7A and FIGS. 5B to 7B, respectively.

In the example shown in FIGS. 5A and 5B, a telephone number display area 121a and a dial keypad 121b including numeric keys and symbolic keys are displayed, as shown in FIG. 5A, which are used as part of a mobile telephone terminal. The dial keypad 121b is equivalent to the virtual buttons (operation buttons), and 15 virtual buttons are arranged on the dial keypad 121b.

When the virtual buttons shown in FIG. 5A are displayed, the logical switch arrangement shown in FIG. 5B is formed in accordance with information stored in the database 109. Specifically, weighting values are assigned to logical switches at positions immediately below places where the 15 virtual buttons denoted SW11 to SW25 are displayed. A numeral indicated in each logical switch is a weighting value assigned to it. In this example, nine logical switches (in a matrix of three columns and three rows) are assigned to a single virtual button. A weighting value of 9 is assigned to the logical switch at the center of the nine logical switches, and a weighting value of 3 is assigned to each of the eight surrounding logical switches.

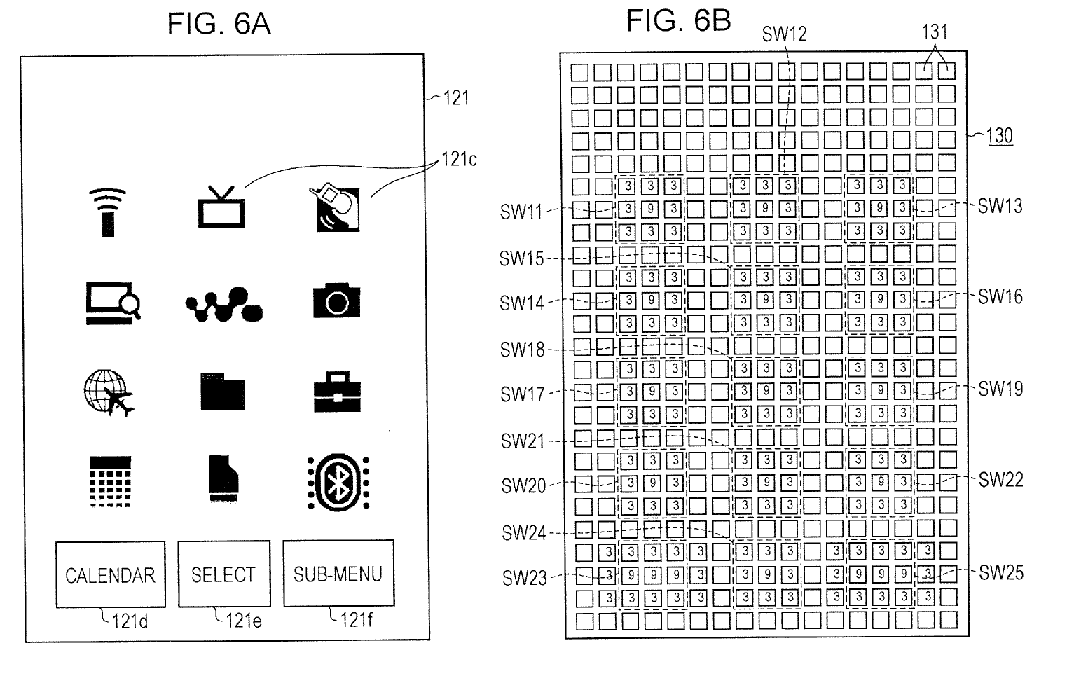

In the example shown in FIGS. 6A and 6B, 12 virtual buttons are formed in correspondence to the icons in an icon display area 121c that indicate functions provided by the terminal device, as shown in FIG. 6A. A CALENDAR button 121d, a SELECT button 121e, and a SUB-MENU buttons 121f are also displayed.

When the virtual buttons shown in FIG. 6A are displayed, the logical switch arrangement shown in FIG. 6B is formed in accordance with information stored in the database 109. Specifically, weighting values are assigned to logical switches at positions immediately below places where the virtual buttons are displayed. A numeral indicated in each logical switch is a weighting value assigned to it. In this example, nine logical switches (in a matrix of three columns and three rows) are assigned to a single virtual button corresponding to an icon in the icon display area 121c. A weighting value of 9 is assigned to the logical switch at the center of the nine logical switches, and a weighting value of 3 is assigned to each of the eight surrounding logical switches. More logical switches are assigned to virtual buttons 121d and 121f according to their display sizes; a weighting value of 3 is assigned to each of the peripheral logical switches, and a weighting value of 9 is assigned to each of the central logical switches.

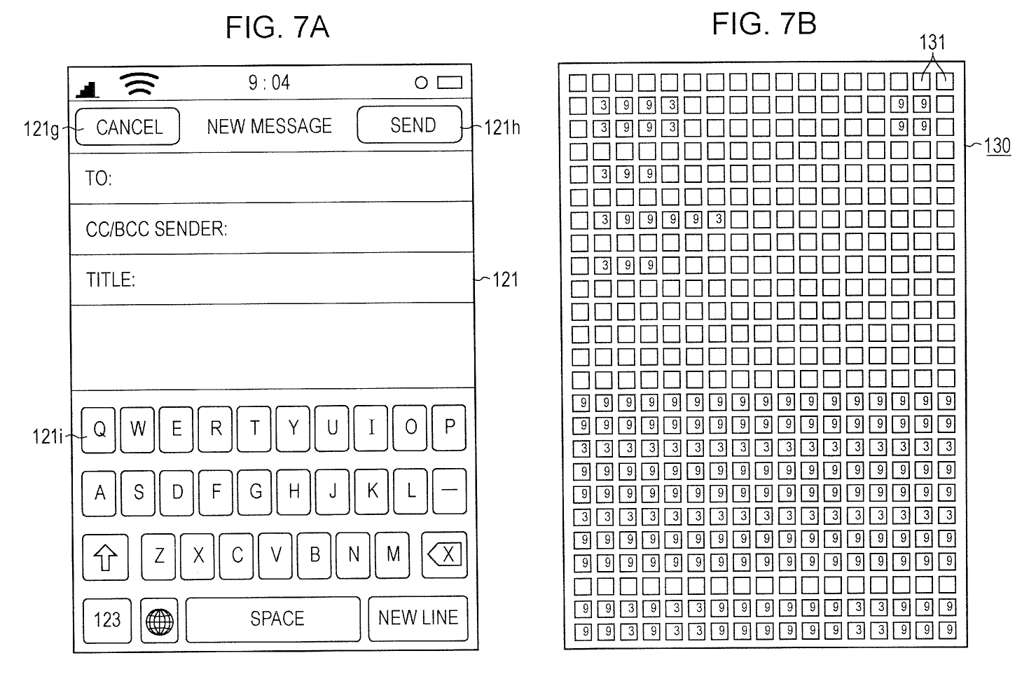

In the example shown in FIGS. 7A and 7B, a mail creation screen is displayed, as shown in FIG. 7A; functional buttons 121g and 121h are displayed in the upper half area as virtual buttons, and virtual buttons 121i constituting a keyboard for use in character input are displayed in the lower half area.

When the virtual buttons shown in FIG. 7A are displayed, the logical switch arrangement shown in FIG. 7B is formed in accordance with information stored in the database 109. Specifically, weighting values are assigned to logical switches at positions immediately below places where the virtual buttons are displayed. A numeral indicated in each logical switch is a weighting value assigned to it. Weighting values of 3 or 9 are assigned to logical switches corresponding to places where function buttons 121g and 121h and the like are displayed. Weighting values of 3 or 9 are consecutively assigned to logical switches at positions immediately below the place where the keyboard is displayed in the lower half area. Although, in FIG. 7B, a specific assignment of logical switches to the keys is omitted, each logical switch basically corresponds to one virtual button (key). However, this is not applied when weighting values are changed so that a logical switch is associated with a plurality of virtual buttons as in a variation (an example in FIGS. 11A and 11B).

1.4 Process to Determine Whether a Virtual Button has been Operated

Next, how a virtual button displayed on the display part 120 is determined to have been operated will be described with reference to the flowchart in FIG. 8. The process in the flowchart in FIG. 8 is executed under control of the system controller 101 shown in FIG. 1.

First, it is assumed that a new screen has been displayed on the display part 120 (step S11). Then, logical switches are assigned to a virtual button displayed on the new screen (step S12), and a weighting value is set for each assigned logical switch (step S13). The logical switch assignment and weighting value setting are carried out in accordance with information stored in the database 109 shown in FIG. 1.

Inputs from logical switches are awaited (step S14). If presses of logical switches are sensed, pressed logical switches are identified (step S15) and a total of the weighting values of the pressed logical switches is obtained (step S16). Only the weighting values of the logical switches corresponding to the relevant virtual button are added.

In this example, whether the total of the weighting values is 9 or more is determined (step S17). If the total is less than 9, it is determined that the virtual button has not been pressed, and the process returns to step S14 to wait for inputs.

If the total is 9 or more in step S17, it is determined that the virtual button corresponding to the logical switches, for which the total has been taken, has been pressed, and an event indicated by the virtual button is generated (step S18).

Then, it is determined that the screen is changed in response to the occurrence of the event (step S19). If the screen is not changed, the process returns to step S14 to wait for inputs. If the screen is changed, the process returns to step S11 to have a new screen corresponding to the event displayed. If the new screen includes a virtual button, processing in step S12 and later is repeated.

Logical switches are assigned in correspondence to a virtual button, which is an operation button, in this way, and whether the virtual button has been pressed is determined in accordance with a result of a comparison between a threshold (9 in this example) and a total (an added value) of the weighting values assigned to the logical switches.

### 1.5 Exemplary Weighting Value Update Process

A weighting value update process in this embodiment will be described next with reference to FIGS. 9A to 9C and FIG. 10.

As described above, whether a virtual button has been operated is determined in accordance with a result of a comparison between the threshold 9 and the total of the weighting values assigned to the logical switches corresponding to the virtual button. A value of 3 or 9 assigned to each logical switch as the weighting value is prestored in the database 109 shown in FIG. 1. When the total of the weighting values is equal to or more than the threshold 9, some of the weighting values are updated in accordance with the state sensed when the logical switches are touched (pressed). How the weighting values are updated will be described below.

FIGS. 9A to 9C illustrate an example in which the assignment of the logical switches corresponding to a virtual button and their weighting values are updated.

FIG. 9A show an example of initial settings. In this example, nine logical switches (in a matrix of three columns and three rows) are assigned in correspondence to virtual button SW1. The logical switch at the center of the nine logical switches is assigned the weighting value 9, and the surrounding eight logical switches are assigned the weighting value 3.

Then, it will be assumed that presses of lower three of the nine logical switches corresponding to virtual button SW1 are sensed as shown in FIG. 9B, for example, each of the lower three logical switches having the weighting value 3. The total weighting value of the pressed logical switches becomes 9 and thereby it is determined that virtual button SW1 has been pressed.

It will be also assumed that two logical switches adjacent to the range of virtual button SW1 have been pressed together, as shown in FIG. 9B, in which P indicates a range of logical switches for which presses have been sensed.

When these presses are sensed, the range of virtual button SW1 is expanded to a range of virtual button SW1′ as shown in FIG. 9C and the weighting values of the pressed logical switches are updated.

Specifically, the logical switches, adjacent to the range of virtual button SW1, for which presses have been sensed together with the presses of the lower three logical switches in virtual button SW1 are newly assigned as part of logical switches corresponding to virtual button SW1′. A relative small weighting value of 1 is assigned to each of the newly assigned logical switches. The weighting values of the lower three of the nine logical switches in virtual button SW1 are updated to 4 by adding 1 to their initial weighting value 3.

The weighting values of the other logical switches remain unchanged.

The flowchart in FIG. 10 illustrates a process by which weighting values are updated in accordance with an actual operation. This process is executed by the logical switch data updating part 108, for example, under control of the system controller 101 shown in FIG. 1, information stored in the database 109 being rewritten with the updated data.

The process will be described according to the flow of the flowchart in FIG. 10. Whether the total of the weighting values of some of the logical switches assigned to a single virtual button, for which presses have been sensed, is equal to or more than the threshold (9 in this example) is determined (step S21). If the total is equal to or more than the threshold, the some of the logical switches assigned to the virtual button are determined to have been pressed and the logical switches adjacent to the logical switches assigned to the virtual button are determined to have been pressed (step S22).

It is determined whether only logical switches other than the logical switch having the highest weighting value (that is, 9) have been pressed, that is, so-called positions shifted from the center of the virtual button have been pressed, in accordance with the decision in steps S22 (step S23). If shifted positions are determined to have been pressed, the weighting value of each logical switch determined to have been pressed in step S22 is incremented by one (step S24). Accordingly, a switch with a weighting value of 3 is updated so that it has a weighting value of 4, and a switch with a weighting value of 0 is updated so that it has a weighting value of 1. A logical switch for which the weighting value has been updated from 0 to 1 is a new logical switch assigned to the virtual button. In this example, the maximum weighting value is 9; even if a switch with a weighting value of 9 is a target to be updated, the weighting value is not updated, that is, remains at 9.

If the total of the weighting values of the logical switches for which presses have been sensed is less than the threshold value in step S21 or if it is determined that the positions shifted from the center of the virtual button have not been pressed in step S23, the sequence is terminated without the updating being performed.

When the assignment of the logical switches corresponding to a virtual button and their weighting values are updated as described above, a logical switch assignment reflecting an actual operation is obtained, enabling a user's virtual button operation to be suitably sensed. In the example shown FIGS. 9A to 9C, for example, if an operation to press positions slightly shifted below the actual center of the virtual button is sensed as shown in FIG. 9B, an area and weighting values are set so that an operation is easily sensed when the logical switches at the shifted positions are pressed. Accordingly, even if a user tends to press lower positions due to the user's operation habit, settings to adapt to the habit can be made and thereby an operation reflecting the user's intention can be sensed.

### 2. Variation of the Embodiment

Next, variations of the processes in the embodiment will be described.

2.1 Exemplary Process when a Plurality of Buttons Overlap

In the example of the update process shown in FIGS. 9A to 9C, the surrounding logical switches of the logical switches assigned to the virtual button are not assigned to another virtual button. However, even if surrounding logical switches of logical switches assigned to a virtual button are already assigned to another virtual button, the process in the embodiment is applicable.

FIGS. 11A and 11B illustrate an example of a process executed in the above case.

It will be first assumed that nine logical switches are assigned to virtual button SW2 and weighting values are set for them and that adjacent nine logical switches are assigned to another virtual button SW3, as shown in FIG. 11A.

The logical switch assignment of virtual button SW2 is updated by the decision process described above.

FIG. 11B illustrates an example of an update, in which case a weighting value of 3 is already assigned to each of the logical switches corresponding to virtual button SW3 and these logical switches are also set as logical switches with a weighting value of 1 for virtual button SW2′. In this way, two weighting values are assigned to a single logical switch. When a decision is made for virtual button SW2′, the weighting value 1 of the two weighting values assigned to the logical switch is used; when a decision is made for virtual button SW3, the weighting value 3 is used.

Even if areas in each of which a virtual button is arranged overlap as shown in FIGS. 11A and 11B, the same effect as in the update example in FIGS. 9A to 9C is obtained.

2.2 Exemplary Process when Values Accumulated in a Plurality of Periods are Used to Make a Decision

In the addition process described so far, which is carried out when a virtual button is determined to have been pressed, only logical switches pressed in the same period are handled. When, however, the update process described above is carried out, added values in a plurality of periods may be accumulated and whether a specific threshold is reached may be determined.

As shown in FIG. 12, for example, scanning periods t1, t2, t3, . . . , in each of which presses of logical switches are sensed, are taken in that order. When a total weighting value becomes a threshold of 20 or more, the relevant virtual button is determined to have been pressed. The logical switches marked a circle, which are partially shown in FIG. 12, are determined to have been pressed.

Under these settings, it will be assumed that the total weighting value of the logical switches corresponding to a particular virtual button is 3 in scanning cycle t1, 6 in scanning cycle t2, and 12 in scanning cycle t3. Then, the virtual button is determined to have been pressed in cycle t3 in which the accumulated value is 20 or more as indicated by the last row in FIG. 12. Weighting values are accumulated only in, for example, a predetermined time.

As described above, an operation can also be suitably determined from accumulated values representing operation states in a predetermined time. When weighting values are updated in the state shown in FIG. 12, for example, the update is performed for all the logical switches that have been determined to have been pressed in all scanning cycles t1, t2, and t3 during which logical switch scanning was performed.

2.3 Example in which the Place of a Virtual Button is Changed

FIGS. 13A, 13B, 14A, and 14B illustrate an example of a process to change a place where a virtual button is displayed. FIG. 13A shows reproduction button SW101 and other operation buttons displayed on a moving picture reproduction screen. FIG. 13B shows logical switches assigned in the touch panel in correspondence to the displayed virtual buttons.

It will be assumed that reproduction button SW101 is displayed at a place different from its initial place, as reproduction button SW101′, which is a virtual button as shown in FIG. 14A. The process to shift the operation button is carried out under control of the system controller 101, for example. The assignment of the logical switches, in the touch panel, corresponding to the virtual button in the initial place is transferred to logical switches corresponding to the virtual button in the new place, as shown in FIG. 14B.

Table 1 shows correspondence between logical switch IDs of virtual button SW101 before it is shifted and their weighting values. After the shift, the logical switch IDs are changed to IDs at new positions, as indicated in Table 2.

TABLE 1

| Logical switch ID | Virtual button ID | Weighting |
|---|---|---|
| 2-3 | SW101 | 3 |
| 2-4 | SW101 | 3 |
| 2-5 | SW101 | 3 |
| 3-3 | SW101 | 3 |
| 3-4 | SW101 | 9 |
| 3-5 | SW101 | 3 |
| 4-3 | SW101 | 3 |
| 4-4 | SW101 | 3 |
| 4-5 | SW101 | 3 |

TABLE 2

| Logical switch ID | Virtual button ID | Weighting |
|---|---|---|
| 11-9 | SW101′ | 3 |
| 11-10 | SW101′ | 3 |
| 11-11 | SW101′ | 3 |
| 12-9 | SW101′ | 3 |
| 12-10 | SW101′ | 9 |
| 12-11 | SW101′ | 3 |
| 13-9 | SW101′ | 3 |
| 13-10 | SW101′ | 3 |
| 13-11 | SW101′ | 3 |

If the weighting values of some logical switches corresponding to virtual button SW101 to be shifted have been updated by the process in the flowchart shown in FIG. 10, the updated weighting values are transferred to virtual button SW101′ in the new place. Alternatively, the updated weighting values may not be transferred and the weighting values of the corresponding logical switches may be updated again in accordance with the operation at the new place.

Although the embodiment described so far has been applied to the touch panel of the electronic device structured as the mobile telephone terminal shown in FIG. 1, the same processes as in the embodiment may be applied to touch panels of other electronic devices. Although the principle of sensing a press (touch) has not been described in the embodiment, various sensing methods that are already practically used or proposed are applicable. The weighting values and threshold described in the embodiment are preferable examples and not limitations.

In the example shown in FIGS. 9A to 9C, in which the assignment of the logical switches corresponding to a virtual button and their weighting values are updated, touches sensed in a single operation have been reflected to the update without alteration, but the update values may be determined from an average in a plurality of operations performed on a single virtual button.

The structure shown in FIG. 1 etc. by which the processes in this embodiment are executed is an example in which the processing parts are partially or entirely formed by hardware, but software in which the processes in the embodiment are executed as a method may be used. When the software is included in existing touch panel control software, the same processes can be executed and thereby the touch panel can be operated easier.

Although, in the embodiment described above, the update process includes a process to expand the assignment of the logical switches corresponding to a virtual button and a process to update the weighting values of some of these logical switches, only one of these two processes may be executed. For example, the weighting values of some of the logical switches corresponding to the virtual button may be changed without their assignment being changed.

The present application contains subject matter related to that disclosed in Japanese Priority Patent Application JP 2009-245589 filed in the Japan Patent Office on Oct. 26, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A touch panel comprising:
an image creating part configured to create a display image including operation buttons;
a display part on which the display image created by the image creating part is displayed;
a touch sensor part including a plurality of logical switches arranged in a matrix in a sensing range to sense touches on a display surface of the display part;
a storage unit configured to store information about relationships between the operation buttons displayed on the display part and the plurality of logical switches;
an operation detecting part configured to use the information stored in the storage unit, add touch-sensing information about each of logical switches at positions corresponding to an operation button displayed on the display unit, the logical switches being part of the plurality of logical switches arranged in a matrix in the sensing range, and detect a touch on the displayed operation button in accordance with an added value; and
an updating part configured to update the information, stored in the storage unit, about the relationships between the operation buttons and the plurality of logical switches, in accordance with the touch-sensing information about each of the logical switches when the touch on the operation button was detected by the operation detecting part.

2. The touch panel according to claim 1, wherein:
the information, stored in the storage unit, about the relationships between the operation buttons and the plurality of logical switches, sets a weighting value to each of the plurality of logical switches;
the operation detecting part detects a touch on the operation button when an added value of weighting values is equal to or more than a specific value; and
the updating part updates the weighting values of logical switches in accordance with the touch-sensing information about each of the logical switches when the touch on the operation button was detected.

3. The touch panel according to claim 2, wherein when touches on positions of logical switches adjacent to the logical switches assigned to the operation button are sensed in addition to the touch on the positions of the logical switches, the updating part assigns and updates weighting values of the adjacent logical switches.

4. The touch panel according to claim 3, wherein when the adjacent logical switches are assigned the weighting values, a single logical switch is assigned different weighting values for a plurality of operation buttons.

5. The touch panel according to claim 2, wherein the operation detecting part uses a value accumulated in a specific number of scanning periods as the added value of the weighting values to detect the touch.

6. An electronic device with a touch panel, comprising:
an image creating part configured to create a display image including operation buttons;
a display part on which the display image created by the image creating part is displayed;
a touch sensor part including a plurality of logical switches arranged in a matrix in a sensing range to sense touches on a display surface of the display part;
a storage unit configured to store information about relationships between the operation buttons displayed on the display part and the plurality of logical switches;
an operation detecting part configured to use the information stored in the storage unit, add touch-sensing information about each of logical switches at positions corresponding to an operation button displayed on the display unit, the logical switches being part of the plurality of logical switches arranged in a matrix in the sensing range, and detect a touch on the displayed operation button in accordance with an added value; and
an updating part configured to update the information, stored in the storage unit, about the a relationships between the operation buttons and the plurality of logical switches, in accordance with the touch-sensing information about each of the logical switches when the touch on the operation button as detected by the operation detecting part.

7. A method of sensing a touch panel operation, comprising the steps of:
creating a display image including operation buttons;
displaying the display image created in the creating step;
sensing touches on a surface, where the display image is displayed, with a plurality of logical switches arranged in a matrix in a sensing range;
detecting a touch on an operation button displayed in the displaying step in accordance with an added value, the added value being obtained by storing information about relationships between the operation buttons displayed in the displaying step and the plurality of logical switches arranged in a matrix in the sensing range, using the stored information, and adding touch-sensing information about each of logical switches at positions corresponding to the operation button, the logical switches being part of the plurality of logical switches arranged in a matrix in the sensing range; and
updating the stored information about the relationships between the operation buttons and the logical switches in accordance with the touch-sensing information about each of the logical switches when the touch on the operation button was detected in the detecting step.
